(19) United States
(12) Patent Application Publication
(10) Pub. No.: US 2008/0060524 A1
(43) Pub. Date: Mar. 13, 2008

(54) Filter Element or Adsorber Element with Enclosed Adsorption Particles and Method for Its Manufacture

(75) Inventors: Manfred Tumbrink, Bad Konig (DE); Matthaus Huber, Reisbach (DE); Reinhard Suss, Marklkofen (DE)

Correspondence Address: GUDRUN E. HUCKETT DRAUDT, SCHUBERTSTR. 15A, WUPPERTAL, 42289, omitted

(73) Assignee: MANN+HUMMEL GMBH, Ludwigsburg (DE)

(21) Appl. No.: 11/854,084

(22) Filed: Sep. 12, 2007

(30) Foreign Application Priority Data
Sep. 13, 2006 (DE) 10 2006 043 729.2

(51) Int. Cl. B01D 53/02; B29C 47/06; B29C 65/34; C09J 5/06

(52) U.S. Cl. 96/154; 156/155; 156/243; 156/305

(57) ABSTRACT

A filter element has a filter medium that is made of at least two filter web layers and an adsorptive layer of adsorptive particles which adsorptive layer is substantially enclosed by the at least two filter web layers with the exception of lateral open edges. A sealing compound seals the lateral open edges at least during manufacture of the filter element. A frame part is attached by injection molding to the filter medium after sealing the open lateral edges with the sealing compound.

### BACKGROUND OF THE INVENTION

The invention relates to a filter element (adsorber element) in particular for cleaning air in motor vehicles, wherein the filter element or adsorber element is comprised of a filter medium that comprises at least two layers of filter webs and an adsorptive layer of adsorptive particles substantially covered by or enclosed between the filter webs.

European patent application 0 759 319 A having a publication date of Feb. 26, 1997, discloses a filter element in which the filter medium is comprised of a continuous zigzag folded arrangement made from a web material that is laterally closed off. In the case of these known filter elements, an endless sealing strip (S) is attached laterally as a frame part during the manufacture of the endless web material with folded filter webs. After cutting to size a required length of the filter webs, profiled strips (E) having a U-shape in cross-section are attached to the end faces and connected to the lateral sealing strips in such a way that the U-shaped profiled sections and the lateral sealing strips provide a stiff frame for the filter insert and thus for the filter element.

Moreover, German utility model 20 2005011 726 U having a publication date of Oct. 27, 2005, discloses a filter insert for a filter element configured as a so-called combination filter, particularly as a filtering and adsorbing element, wherein the filter insert has a continuous folded zigzag structure and comprises particles with excellent adsorption properties, for example, activated carbon, enclosed between two layers of filter webs. At the end faces of the filter medium, i.e., at the respective terminal folds, by means of gluing these folds to a profiled section provided as a frame, the filter webs and the enclosed particles are sealed by means of the glue so that by means of this seal it is prevented that the particles can flow out of the layers of filter webs.

### SUMMARY OF THE INVENTION

It is an object of the present invention to provide a filter element (adsorber element) of the aforementioned kind with at least two layers of filter webs and an adsorptive layer of adsorptive particles which adsorptive layer is substantially enclosed or covered by the filter webs.

According to the present invention this is achieved in that advantageously the lateral open edges of the filter webs and the adsorptive layer of adsorptive particles enclosed between or covered by the filter webs are sealed by a sealing compound at least during the manufacturing process of the filter element. Preferably, the layers of the filter webs are folded in zigzag shape.

The adsorptive particles can be, for example, activated carbon particles but other absorptive materials can be used also. For example, ion exchanger materials, in particular ion exchanger resins or comparable materials, can be used in this connection.

The sealing compound can be advantageously a wax material that when heated will liquefy and when cooled will solidify but it can also be a glue or any other comparable substance. In the alternative, this sealing compound can be generated in that, by means of a thermal method (heating, laser or the like) or a chemical method (etching), the edge area of the layers of the filter webs are softened or melted.

In a method according to the invention for producing the afore described filter element, the zigzag folded layers of the filter webs that are cut to the required size and contain the enclosed layer of adsorptive particles are held in a holding device that has an applicator head for applying or introducing the soft compound. After application or introduction of the soft sealing compound and formation of sealed lateral edges, the frame part is advantageously produced laterally by injection molding in an injection molding device for plastic material.

By means of the applicator head, a metered amount of heated wax can be sprayed through a nozzle, for example, onto the lateral edge areas of the layers or, alternatively, the lateral edge areas of the filter webs can be supplied with heated wax in that, with a ladle as an applicator head, the lateral edge areas of the filter medium are wetted with heated wax, i.e., the lateral edges are immersed in heated wax.

This prefabrication of the filter medium in accordance with the present invention for producing a filter element with, for example, activated carbon media, is generally done downstream of a so-called folding sword folding device for producing the zigzag folds (pleats) and after the step of cutting to size. The sealing of the thus resulting cut edges can then be realized by applying the initially soft sealing compound by means of the applicator head, for example, by means of a glue nozzle, wherein the applied quantity can be controlled by the nozzle of the applicator head and the penetration depth of the wax can be controlled by the quantity of the applied wax.

In the alternative employing a ladle, the wax is applied essentially by means of an immersion process. For this purpose, the terminal folds of the filter webs to be sealed are fixed in the holding device for the sealing action and subsequently the ladle moves upwardly and wets the edges of the filter webs.

By means of the invention a series of problems, in particular in connection with embedding in plastic material by injection molding for producing the frame part of the filter element, can be minimized in regard to their effects in a simple way. In the manufacture of filter elements of the aforementioned kind, referred to also as combination filters in pleated form, problems occur in the injection molding step for producing the plastic frame at the time of closing the injection mold because the filter medium (filter webs and enclosed particles) can be destroyed or particles (activated carbon or similar materials) can be destroyed. This causes dust to be formed and the dust falls out of the filter medium. On the other hand, when the gap of the injection mold is too wide, the injected plastic material penetrates too far into the filter medium and unwanted over-molding results.

In order to prevent this, the sealing actions in accordance with the present invention are proposed according to which the cut edges before insertion into the injection mold are sealed. In this way, the edge area of the pleated filter medium is substantially closed off and the injection mold can be closed without any negative effects; the soft sealing compound can give way or yield without this causing particles to be destroyed. Over-molding is substantially prevented in the injection molding process.

### BRIEF DESCRIPTION OF THE DRAWING

One embodiment of the invention will be explained in connection with the drawings in more detail.

FIG. 1 shows a section of the filter medium comprised of two zigzag shaped folded filter webs and enclosed adsorptive particles.

FIG. 2 is a schematic illustration of the filter element with sealed lateral edges of the filter medium.

### DESCRIPTION OF THE PREFERRED EMBODIMENTS

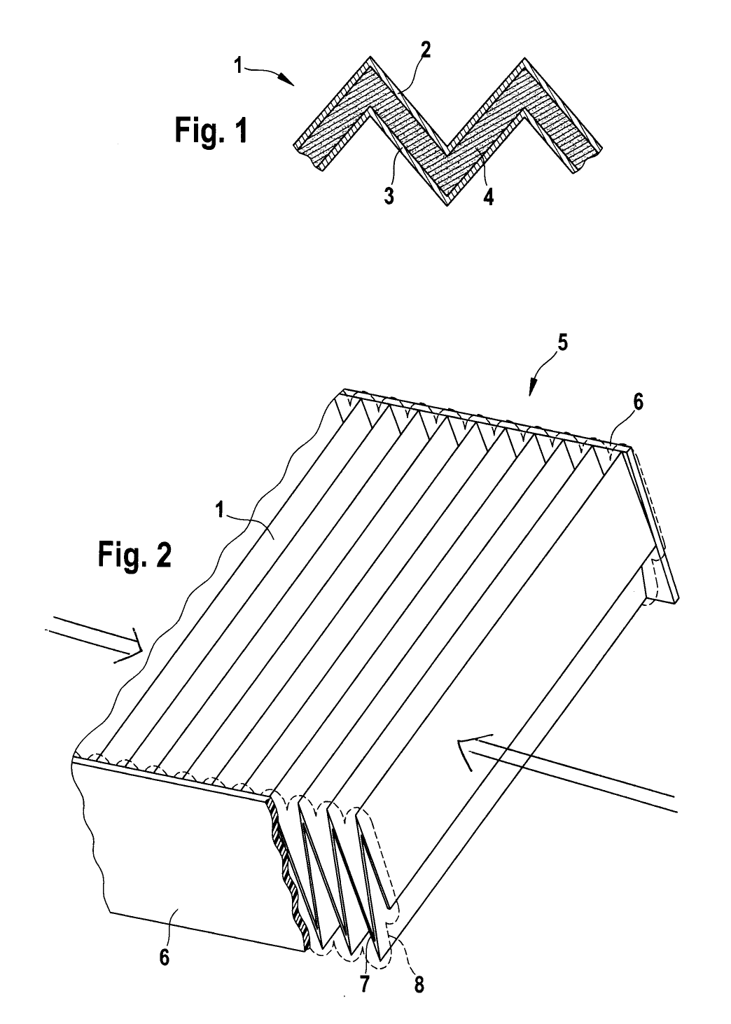

FIG. 1 shows a section of a filter medium 1 that, for example, can be used as an air filter for the intake of an internal combustion engine or as a filter for the interior of a passenger compartment of a vehicle. Layers of zigzag-shaped folded filter webs 2 and 3 are present between which an adsorptive layer of adsorptive particles 4, in the illustrated embodiment, activated carbon, is enclosed.

FIG. 2 shows a filter element 5 comprising in the lateral edge area a frame part 6 that mechanically secures the filter medium 1 at its lateral edges 7.

On the lateral edges 7 of the filter medium 1, a sealing compound 8 is applied; it is illustrated in dashed lines. For example, the compound 8 can be a wax that is liquefied by heat and that hardens or solidifies when cooled. However, the materials and methods described above in this specification can be used also.

For producing the filter element 5, the zigzag-shaped folded filter medium 1 that has been cut to the desired size is secured in a holding device (illustrated only schematically by the double arrows in FIG. 2); subsequently, the initially soft sealing compound 8 is applied to the open lateral edges by means of an appropriately designed applicator head in the form of a glue nozzle or a ladle and the sealing compound 8 penetrates into the filter medium 1 to a minimal depth so that the open lateral edges are now sealed and sealed lateral edges 7 are produced. After application or introduction (penetration) of the sealing compound 8, the frame part 6 is then laterally molded onto the filter medium 1 by means of an injection molding device for plastic material.

The specification incorporates by reference the entire disclosure of German priority document 10 2006 043 729.2 having a filing date of Sep. 13, 2006.

While specific embodiments of the invention have been shown and described in detail to illustrate the inventive principles, it will be understood that the invention may be embodied otherwise without departing from such principles.

What is claimed is:

1. A filter element comprising:
a filter medium comprising at least two filter web layers and an adsorptive layer of adsorptive particles which adsorptive layer is substantially enclosed by the at least two filter web layers with the exception of lateral open edges;
a sealing compound sealing the lateral open edges at least during manufacture of the filter element.

2. The filter element according to claim 1, wherein the at least two filter web layers are zigzag-shaped folded layers.

3. The filter element according to claim 2, further comprising a fame part connected at least to the lateral edges for mechanically securing the filter medium.

4. The filter element according to claim 3, wherein the frame part is an injection-molded plastic part.

5. The filter element according to claim 1, wherein the adsorptive particles are activated carbon particles.

6. The filter element according to claim 1, wherein the adsorptive particles are ion exchanger particles.

7. The filter element according to claim 1, wherein the adsorptive particles are ion exchanger resin particles.

8. The filter element according to claim 1, wherein the sealing compound is a wax that liquefies when heated and solidifies when cooled.

9. The filter element according to claim 1, wherein the sealing compound is a glue.

10. The filter element according to claim 1, wherein the sealing compound is an edge area of the at least two filter web layers that is softened or melted by a thermal method or a chemical method.

11. A method for producing a filter element according to claim 2, the method comprising the steps of:
securing a filter medium, comprising at least two zigzag-shaped folded filter web layers and an adsorptive layer of adsorptive particles enclosed between the at least two zigzag-shaped folded filter web layers, in a holding device;
applying a sealing compound to open lateral edges of the filter medium to seal the open lateral edges to produce sealed lateral edges; and
injection molding a frame part laterally onto the filter medium provided with the sealed lateral edges.

12. The method according to claim 11, wherein in the step of applying a metered amount of heated wax is sprayed onto the open lateral edges of the filter medium.

13. The method according to claim 11, wherein in the step of applying the open lateral edges are immersed into heated wax.

14. A method for producing a filter element comprising a filter medium comprising at least two filter web layers and an adsorptive layer of adsorptive particles which adsorptive layer is substantially enclosed by the at least two filter web layers with the exception of lateral open edges; the method comprising the step of:
sealing the lateral open edges of the filter medium with a sealing compound before a frame part is applied to the filter medium.
